(19) United States
(12) Patent Application Publication
(10) Pub. No.: US 2006/0238700 A1
(43) Pub. Date: Oct. 26, 2006

(54) Eye glasses with lightened frame and process for making them

(76) Inventor: Paola Del Vecchio, Agordo (Belluno) (IT)

Correspondence Address: ARENT FOX PLLC, 1050 CONNECTICUT AVENUE, N.W., SUITE 400, WASHINGTON, DC, 20036, US

(21) Appl. No.: 10/555,095

(22) PCT Filed: Apr. 30, 2004
(86) PCT No.: PCT/IB04/01329

§ 371 Date: Nov. 2, 2005

(30) Foreign Application Priority Data
May 8, 2003 (IT) BO2003A000283

(51) Int. Cl. G02C 1/04

(52) U.S. Cl. 351/103

(57) ABSTRACT

Eye glasses with a lightened frame are made using a process in which at least one part of the eye glass frame is made lighter by making at least one cavity in it.

### TECHNICAL FIELD

The present invention relates to eye glasses, especially eye glasses suitable for sporting or similar uses, and to a process for making such eye glasses or portions of them.

### BACKGROUND ART

Eye glasses known up to the present time have a full and rather heavy frame which, besides being uncomfortable to wear, may under certain circumstances constitute a disadvantage because, for example, they sink and may be irrecoverably lost if they fall in water.

Further, the surface finish of known glasses, which are made by moulding a plastic material—such as nylon, for example—is not entirely satisfactory on account of rough edges and other imperfections which make it impossible to use the mould to best advantage.

Moreover, in known eye glasses, the shrinkage of the material after moulding produces small unwanted surface bulges which are very unattractive.

### SUMMARY OF THE INVENTION

The invention therefore provides eye glasses comprising a mounting frame that has at least one portion made of a suitable material, especially plastic, and preferably rigid or semi-rigid plastic; the eye glasses being characterised in that said portion of the eye glasses presents at least one internal cavity.

The invention also provides a process for making eye glasses where at least one portion of the eye glass mounting frame is made from a suitable material, especially plastic, and preferably rigid or semi-rigid plastic; the process being characterised in that it involves making at least one internal cavity in said portion of the eye glasses.

It is therefore possible to make eye glasses with a very light frame.

### BRIEF DESCRIPTION OF THE DRAWINGS

The technical characteristics and advantageous aspects of the invention are apparent from the detailed description which follows, with reference to the accompanying drawings, which illustrate preferred embodiments of the invention provided merely by way of example without restricting the scope of the inventive concept, and in which:

FIG. 1 is a front view of a first embodiment of eye glasses made using the process according to the present invention;

FIG. 2 is a perspective side view of the front of the eye glasses according to the first embodiment of the present invention;

FIG. 3 is an enlarged cross section through line III-III in FIG. 1;

FIG. 4 is a front view of a second embodiment of eye glasses made using the process according to the present invention;

FIG. 5 is a side view of the eye glasses made according to the second preferred embodiment of the present invention;

FIG. 6 is a perspective view of the eye glasses according to the second preferred embodiment of the invention, complete with sidepieces and nose pads;

FIG. 7 is a cross section, through line VII-VII of FIG. 4, showing the bridge area at the front of the frame in the second preferred embodiment of the eye glasses according to the invention.

### DESCRIPTION OF THE PREFERRED EMBODIMENTS OF THE INVENTION

In the process for manufacturing eye glasses according to the present invention, a portion of the eye glass frame is made by injection moulding and has at least one hollow area or cavity filled with a gas.

More specifically, the gas filled hollow area or cavity in the eye glass frame is made by injecting the gas at a predetermined pressure into the material of which the eye glass frame is made while the material is still in a fluid state inside the mould.

Advantageously, in the process according to the present invention, the gas used to make the hollow area or cavity in the eye glass frame is nitrogen. However, other gases might also be used without departing from the scope of the inventive concept.

The gas under pressure inside the cavity in the eye glasses makes it possible not only to reduce the weight of the eye glass frame he eye glasses lighter but also to produce a frame whose cross section offers good rigidity and resistance. Moreover, eye glasses made according to the invention have better elastic properties compared to prior art glasses made from the same material.

With reference to the accompanying drawings, the numeral 10 denotes in their entirety eye glasses made according to the first preferred embodiment of the invention.

As illustrated, the eye glasses 10 comprise a frame for mounting a first and a second lens 12 and 14, and a frame front portion 16 made, for example, of nylon and consisting of a first and a second eyepiece portion 11 and 13, connected by a bridge 15.

The eye glasses further comprise sidepieces made of the same material, labelled 17 and 19 and illustrated schematically with dashed lines in the accompanying drawings.

The reference numerals 21 and 23 denote nose pads, also illustrated schematically with dashed lines, mounted on corresponding protuberances 25, 27 on the front frame portion extending from the inside edge of respective eyepieces towards the wearer's face. The protuberances 25 and 27 comprise means for attaching the nose pads and consisting, more specifically, of corresponding pad arms 31 and 33.

As illustrated, the eye glass frame comprises a hollow area 18 defining a cavity 20 filled with the gas.

As illustrated, the hollow area or cavity 20 for holding the gas inside the eye glass frame consists of a lengthwise duct extending circumferentially around the eyepieces of the frame front portion.

The gas is injected through a central point 24 at the nose pad 13 and spreads uniformly in the bridge and eyepieces of the eye glasses, creating a closed perimetric duct or channel. After injecting the nitrogen, the filling point 24 is sealed.

As illustrated, the lengthwise duct has a portion 22a that extends advantageously in the top part of the eyepiece, along respective branches 20a and 20b, and a portion 22b extending along the inside of the eyepiece, that is to say, along the side facing the other eyepiece.

The lengthwise duct might also extend along the bottom and outer portions of the eyepiece, thus running right around each eyepiece portion of the frame.

Advantageously, the cross section size of the gas filled duct or area 22 at any one point may be made to depend on the cross section size of the eye glass frame at that point.

In practice, where the eye glass frame widens, so the duct section widens accordingly, as in the parts 22c at the sides of the frame where the sidepieces are connected.

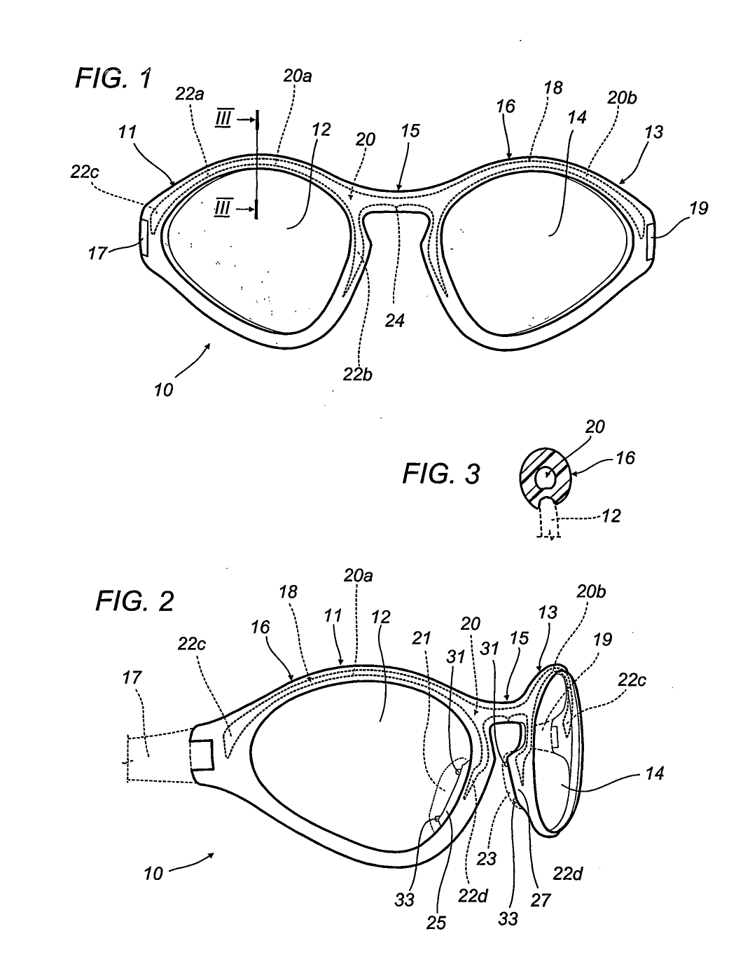

More specifically, as clearly illustrated in FIG. 2, the eye glasses might be made even lighter by extending the gas-filled duct into the protuberances 25 and 27, each mounting a respective nose pad, thus creating a gas-filled duct with a section 22d whose direction changes sharply compared to the rest of the duct which follows the general shape of the frame.

To avoid excessively weakening the eye glass frame, the duct might be made only in the parts of it having a predetermined minimum cross section size.

Although not specifically illustrated, the front frame portion might comprise a plurality of separate hollow areas or cavities containing gas. The separate hollow areas or cavities for the filler gas might also be made inside the sidepieces or other parts of the eye glass frame.

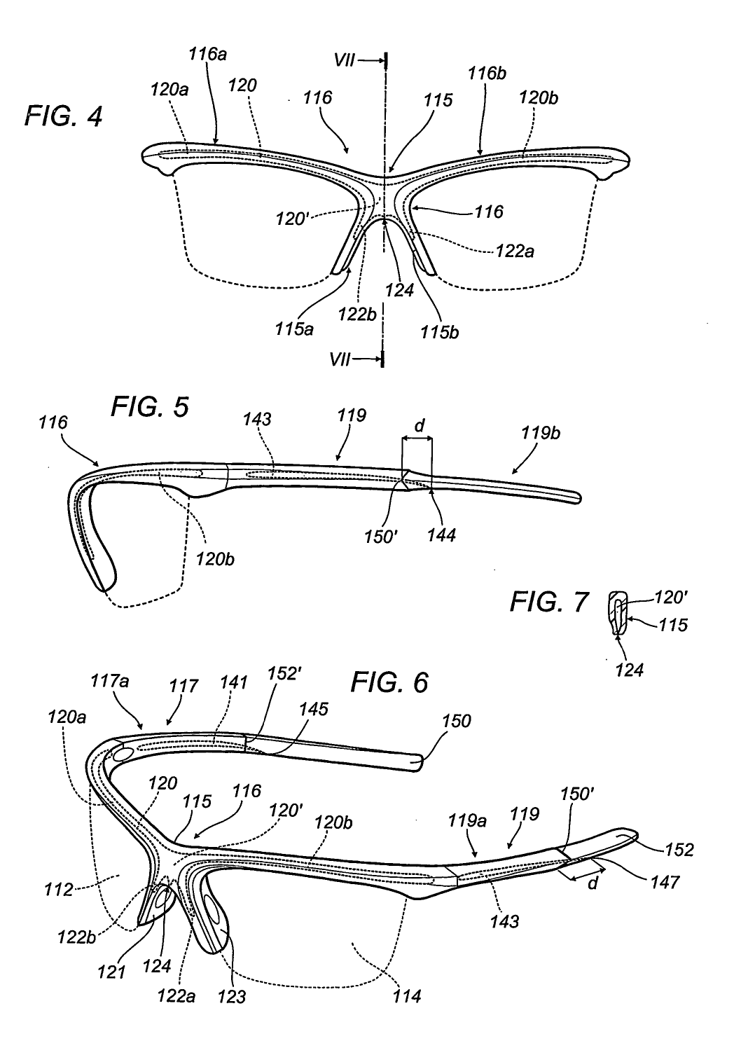

A second embodiment of the eye glasses made using the process according to the invention is illustrated in FIGS. 4 to 7. In this second embodiment, too, the eye glasses comprise a mounting frame with portions 116, 117, 119 made of a suitable material, preferably rigid or semi-rigid plastic (and more specifically, nylon), which have respective internal cavities, labelled 120, 141, 143, respectively.

In this second embodiment, too, the internal cavity 120, 141, 143 is made in the respective eye glass portion 116, 117, 119, by injecting into the eye glass portion 116, 117, 119 a filler gas, which preferably consists of or comprises nitrogen, at a predetermined pressure during the hot moulding of the plastic material to make the eye glass portion 116, 117, 119.

In addition, according to another advantageous aspect of the second preferred embodiment, once the hollow area has been made in the eye glass portion 116, 117, 119, the gas is allowed to escape from the portion 116, 117, 119 and the opening 124, 144 through which the gas was filled into the eye glass portion 116, 117, 119 is sealed.

More specifically, the opening 124, 144 for injecting the gas into the eye glass portion 116, 117, 119 is sealed by heating the material of which the portion 116, 117, 119 is made after the eye glass frame has been removed from the mould.

In this second embodiment, too, the internal cavity has the shape of a lengthwise duct 120, 141, 143 as shown in the accompanying drawings.

Looking in more detail with reference to the drawings, one portion 116 of the eye glasses with lightened frame is constituted by the front of the frame which mounts a first and a second lens 112, 114, drawn with dashed lines.

More specifically, the lengthwise duct 120 is made in the top section of the eye glass frame front 116 and extends in the part of the frame front 116 where the nose pads 121, 123 are located.

Advantageously, the internal cavity 120 extends from a point half way along the respective eye glass portion 116, that is to say, from the midpoint of the respective eye glass portion 116.

In an especially advantageous manner, the internal cavity 120 extends from the lower surface of the bridge 115 of the eye glass frame front portion 116.

As illustrated in the accompanying drawings, the internal cavity 120 thus advantageously extends along two branch channels 120a, 120b following substantially opposite directions.

A further advantageous aspect lies in the fact that the internal cavity 120 extends along the full width and height of the connecting bridge 115. In practice, that means an internal chamber 120′ that is substantially the same size as the connecting bridge 115 is formed.

Thus, the internal cavity 120 in the front of the eye glass frame comprises a wide chamber 120′ just downstream of the injection point opening 124, from which there extend a plurality of channels 120a, 120b, 122a, 122b in the directions of respective branches 116a, 116b, 115a, 115b of the eye glass portion 116, the channels 120a, 120b extending in directions substantially transversal and the channels 122a, 122b in directions substantially perpendicular to the eye glass front portion.

Advantageously, the method for making the internal cavity according to the invention thus produces a cavity with a first and a second branch channel 122a, 122b extending in a direction substantially opposite the direction in which the gas is injected into the eye glass portion, and, more specifically, extending in the area 115a, 115b, of the eye glass frame front 116 where the nose pads 121, 123 are located.

As illustrated, according to another aspect, the eye glass portion comprises respective sidepieces 117, 119 of the eye glass frame.

The internal cavities 141, 143 in the eye glass sidepieces extend from an intermediate point of the sidepieces 117, 119, located in an end area 119a to be coated with suitable material 150, 152 for contact with the wearer's head or ears and extending towards the area of connection to the front portion of the eye glass frame.

As illustrated, the injection point 145, 147, which is situated in an end area 119a to be coated, is separated from the intermediate end 150′, 152′ of the area to be coated by a gap (d) such that the channel in the corresponding non-coated sidepiece portion 119a can extend in a direction that is substantially parallel to the direction in which the portion 117a, 119a itself extends.

More specifically, the internal cavity extends, as illustrated, from a point located in an area 119b where the cross section of the sidepiece is reduced or narrower than the cross section at the front 119a of the sidepiece.

The material of which the eye glass frame is made, that is to say, which constitutes the front portion and/or the sidepieces of the frame, may be opaque or transparent and, in the latter case, the respective internal cavities are clearly visible and produce an attractive effect.

According to another advantageous aspect, the inside surface defining the internal cavity may be coloured or otherwise suitably treated, thus highlighting the cavity when the respective portion of the eye glass frame is made from a transparent material.

The invention therefore provides an eye glass frame which is very light but whose mechanical strength is not significantly reduced.

One advantage of the eye glasses made according to the invention is that they may be more easily recovered from water because they float. Thus, there is no longer the risk of the wearer irrecoverably losing the eye glasses if they fall into the water.

Furthermore, the use of a gas injected under pressure into the eye glass frame makes it possible to improve eye glass finish, producing a surface that is smoother and free of rough edges and irregularities.

According to another advantageous aspect, the areas in which gas is injected under pressure into the eye glass frame reduce the effect of plastic shrinkage which, in eye glasses made of nylon for example, produces unwanted surfaces bulges.

It will be understood that the invention can be modified and adapted in several ways without thereby departing from the scope of the inventive concept. Moreover, all the details of the invention may be substituted by technically equivalent elements.

1. A process for making eye glasses where at least one portion (16, 116, 117, 199) of the eye glass mounting frame is made from a suitable material, especially plastic, and preferably rigid or semi-rigid plastic; the process being characterised in that it involves making at least one internal cavity (20, 120, 141, 143) in said portion (16, 116, 117, 199) of the eye glasses.

2. The process according to claim 1, characterised in that the internal cavity (20, 120, 141, 143) is made in the eye glass portion (16, 116, 117, 119) by injecting a filler gas into the eye glass portion (16, 116, 117, 119).

3. The process according to claim 2, characterised in that the gas comprises nitrogen.

4. The process according to claim 2 or 3, characterised in that the gas is injected into the eye glass portion (16, 116, 117, 119) at a predetermined pressure.

5. The process according to claim 2, characterised in that the filler gas is injected into the eye glass portion (16, 116, 117, 119) during the hot moulding of the eye glass portion (16, 116, 117, 119) itself.

6. The process according to claim 2, characterised in that once the internal cavity has been made in the eye glass portion (16, 116, 117, 119), the gas is allowed to escape from the portion (16, 116, 117, 119).

7. The process according to claim 2, characterised in that an opening (24, 124, 144) through which the filler gas is injected into the eye glass portion (16, 116, 117, 119) is sealed.

8. The process according to claim 7, characterised in that the opening (24, 124, 144) through which the filler gas is injected into the eye glass portion (16, 116, 117, 119) is sealed by heating the material of which the portion (16, 116, 117, 119) is made.

9. The process according to claim 1, characterised in that the internal cavity (20, 120, 141, 143) is made in a portion (16, 116, 117, 119) of the eye glass frame with a predetermined minimum cross section size.

10. The process according to claim 1, characterised in that the internal cavity (20) has a variable cross section size.

11. The process according to claim 10, characterised in that the internal cavity (20, 22d) at any one point has a cross section size that depends on the cross section size of the eye glass frame at that point.

12. The process according to claim 1, characterised in that the eye glass portion (16, 116, 117, 119) is constituted by the front of the frame which mounts a first and a second lens (12, 14, 112, 114).

13. The process according to claim 1, characterised in that the internal cavity is made in the form of a lengthwise duct (20, 120, 141, 143).

14. The process according to claim 1, characterised in that the internal cavity (20, 120) has at least a first and a second branch channel (20a, 20b, 120a, 120b) extending in substantially opposite directions.

15. The process according to claim 1, characterised in that the internal cavity (20, 120) is made in the top section of the eye glass frame front (16, 116).

16. The process according to claim 1, characterised in that the internal cavity is made in the lower section of the frame front.

17. The process according to claim 1, characterised in that the internal cavity is made to extend right around each respective eyepiece of the front of the frame.

18. The process according to claim 1, characterised in that the internal cavity (22b, 122b) is made in the part of the eye glass frame front (16, 116) where the nose pads (21, 23, 121, 123) are located.

19. The process according to claim 1, characterised in that the internal cavity (20, 120) is made to extend from an intermediate point of the respective eye glass portion (16, 116, 117, 119).

20. The process according to claim 1, characterised in that the internal cavity (20, 120) is made to extend from a midpoint of the respective eye glass portion (16, 116, 117, 119).

21. The process according to claim 1, characterised in that the internal cavity (20, 120) is made to extend from the bridge (15, 115) of the front portion (16, 116) of the eye glasses.

22. The process according to claim 1, characterised in that the internal cavity (20, 120) is made to extend from the lower surface of the bridge (15, 115) of the front portion (16, 116) of the eye glasses.

23. The process according to claim 1, characterised in that the internal cavity (20, 120) is made to extend in at least two substantially opposite directions (20a, 20b, 120a, 120b).

24. The process according to claim 1, characterised in that the internal cavity (20, 120) is made to extend substantially along the full width of the connecting bridge (15, 115).

25. The process according to claim 1, characterised in that the internal cavity (20, 120) is made to extend substantially along the full height of the connecting bridge (15, 115).

26. The process according to claim 1, characterised in that the internal cavity (20, 120) is substantially the same size as the connecting bridge (15, 115).

27. The process according to claim 1, characterised in that the internal cavity (120) comprises a wide chamber (120′) situated just downstream of the injection point opening (124).

28. The process according to claim 1 characterised in that the internal cavity (120) comprises a large chamber (120′).

29. The process according to claim 1, characterised in that the internal cavity (120) comprises a central chamber (120′) from which there extend a plurality of channels (120a, 120b, 122a, 122b) in the directions of respective branches (116a, 116b, 115a, 115b) of the eye glass portion (116).

30. The process according to claim 1, characterised in that the internal cavity (120) comprises a central chamber (120′) from which there extend a plurality of channels (120a, 120b, 122a, 122b), the channels (120a, 120b) in a direction transversal to, and the channels (122a, 122b) in a direction perpendicular to, the front eye glass portion.

31. The process according to claim 1, characterised in that the internal cavity has at least one branch channel (122a, 122b) extending in a direction substantially opposite the direction in which the gas is injected into the eye glass portion.

32. The process according to claim 1, characterised in that the eye glass portion comprises a sidepiece (117, 119) of the eye glass frame.

33. The process according to claim 1, characterised in that the internal cavity (141, 143) is made to extend from an intermediate point of the sidepiece (117, 119).

34. The process according to claim 1, characterised in that the internal cavity (141, 143) is made to extend from a point (145, 147) located in an end area (119a) to be coated with suitable material (150, 152) towards the area of connection to the front portion of the eye glass frame.

35. The process according to claim 1, characterised in that the injection point (145, 147), which is situated in an end area (119b) to be coated, is separated from the end of the area to be coated by a gap (d) such that the channel can extend in a direction that is substantially parallel to the direction in which the corresponding portion (117a, 119a) extends.

36. The process according to claim 1, characterised in that the internal cavity (143) is made to extend from a point in an area (119b) with a reduced or narrow cross section.

37. Eye glasses comprising a mounting frame that has at least one portion (16, 116, 117, 119) made of a suitable material, especially plastic, and preferably rigid or semi-rigid plastic; the eye glasses being characterised in that said portion (16, 116, 117, 119) of the eye glasses presents at least one internal cavity (20, 120, 141, 143).

38. The eye glasses according to claim 37, characterised in that the internal cavity (20, 120, 141, 143) is made in the eye glass portion (16, 116, 117, 119) by injecting a filler gas into the eye glass portion (16, 116, 117, 119).

39. The eye glasses according to claim 38, characterised in that the gas comprises nitrogen.

40. The eye glasses according to claim 38 or 39, characterised in that the gas is injected into the eye glass portion (16, 116, 117, 119) at a predetermined pressure.

41. The eye glasses according to claim 38, characterised in that the filler gas is injected into the eye glass portion (16, 116, 117, 119) during the hot moulding of the eye glass portion (16, 116, 117, 119) itself.

42. The eye glasses according to claim 38, characterised in that once the hollow area has been made in the eye glass portion (16, 116, 117, 119), the filler gas is allowed to escape from the portion (16, 116, 117, 119).

43. The eye glasses according to claim 38, characterised in that the opening (24, 124, 144) through which the filler gas is injected into the portion (16, 116, 117, 119) is sealed.

44. The eye glasses according to claim 43, characterised in that the opening (24, 124, 144) through which the filler gas is injected into the eye glass portion (16, 116, 117, 119) is sealed by heating the material of which the portion (16, 116, 117, 119) is made.

45. The eye glasses according to claim 37, characterised in that the internal cavity (20, 120, 141, 143) is made in a portion (16, 116, 117, 119) of the eye glass frame with a predetermined minimum cross section size.

46. The eye glasses according to claim 37, characterised in that the internal cavity (20, 120, 141, 143) has a variable cross section size.

47. The eye glasses according to claim 46, characterised in that the internal cavity at any one point has a cross section size that depends on the cross section size of the eye glass frame at that point.

48. The eye glasses according to claim 37, characterised in that the eye glass portion (16, 116, 117, 119) is constituted by the front of the frame which mounts a first and a second lens (12, 14, 112, 114).

49. The eye glasses according to claim 37, characterised in that the internal cavity (20, 120, 141, 143) consists of a lengthwise duct.

50. The eye glasses according to claim 37, characterised in that the internal cavity (20, 120) has at least a first and a second branch channel (20a, 20b, 120a, 120b) extending in substantially opposite directions.

51. The eye glasses according to claim 37, characterised in that the internal cavity (20, 120) is made in the top section of the eye glass frame front (16, 116).

52. The eye glasses according to claim 37, characterised in that the internal cavity is made in the lower section of the eye glass frame front.

53. The eye glasses according to claim 37, characterised in that the internal cavity extends right around the respective eyepiece portion of the frame.

54. The eye glasses according to claim 37, characterised in that the internal cavity (22b, 122a, 122b) extends in the part of the front (16, 116) of the frame (115a, 115b) where the nose pads (21, 23, 121, 123) are located.

55. The eye glasses according to claim 37, characterised in that the internal cavity (20, 120) extends from an intermediate point of the respective eye glass portion (16, 116, 117, 119).

56. The eye glasses according to claim 37, characterised in that the internal cavity (20, 120) extends from a central or middle point of the respective eye glass portion (16, 116, 117, 119).

57. The eye glasses according to claim 37, characterised in that the internal cavity (20, 120) extends from the bridge (15, 115) of the front portion (16, 116, 117, 119) of the eye glasses.

58. The eye glasses according to claim 37, characterised in that the internal cavity (20, 120) extends from the lower surface of the bridge (15, 115) of the front portion (16, 116, 117, 119) of the eye glasses.

59. The eye glasses according to claim 37, characterised in that the internal cavity (20, 120) extends in at least two substantially opposite directions (20, 20b, 120a, 120b).

60. The eye glasses according to claim 37, characterised in that the internal cavity (20, 120) extends substantially along the full width of the connecting bridge (15, 115).

61. The eye glasses according to claim 37, characterised in that the internal cavity (20, 120) extends substantially along the full height of the connecting bridge (15, 115).

62. The eye glasses according to claim 37, characterised in that the internal cavity (20, 120) is substantially the same size as the connecting bridge (15, 115).

63. The eye glasses according to claim 37, characterised in that the internal cavity (120) comprises a wide chamber (120′) situated just downstream of the injection point opening (124).

64. The eye glasses according to claim 37, characterised in that the internal cavity (120) comprises a large chamber (120′).

65. The eye glasses according to claim 37, characterised in that the internal cavity (120) comprises a central chamber (120′) from which there extend a plurality of channels (120a, 120b, 122a, 122b) in the directions of respective branches (116a, 116b, 115a, 115b) of the eye glass portion (116).

66. The eye glasses according to claim 37, characterised in that the hollow area comprises a central chamber (120′) from which there extend a plurality of channels (120a, 120b, 122a, 122b), the channels (120a, 120b) in a direction transversal to, and the channels (122a, 122b) in a direction perpendicular to, the front eye glass portion.

67. The eye glasses according to claim 37, characterised in that the internal cavity comprises at least one branch channel (122a, 122b) extending in a direction substantially opposite the direction in which the gas is injected into the eye glass portion.

68. The eye glasses according to claim 37, characterised in that the eye glass portion comprises a sidepiece (117, 119) of the eye glass frame.

69. The eye glasses according to claim 37, characterised in that the internal cavity (141, 143) extends from a point (145, 147) of the respective sidepiece located in an end area (119a) to be coated with suitable material (150, 152) towards the area of connection to the front portion of the eye glass frame.

70. The eye glasses according to claim 37, characterised in that the injection point (145, 147), which is situated in an end area (119a) to be coated, is separated from the end of the area to be coated by a gap (d) such that the channel can extend in a direction that is substantially parallel to the direction in which the corresponding portion (117a, 119a) extends.

71. The eye glasses according to claim 37, characterised in that the internal cavity (143) extends from a point in an area (199b) with a reduced or narrow cross section.

72. The eye glasses according to claim 37, characterised in that the material of which the eye glass frame is made is transparent.

73. The eye glasses according to claim 37, characterised in that the inside surface defining the internal cavity is coloured.
